(19) United States
(12) Patent Application Publication
(10) Pub. No.: US 2006/0101464 A1
(43) Pub. Date: May 11, 2006

(54) Determining a number of processors to execute a task

(76) Inventor: Stephen H. Dohrmann, Hillsboro, OR (US)

Correspondence Address: KONRAD RAYNES & VICTOR, LLP, 315 S. BEVERLY DRIVE, # 210, BEVERLY HILLS, CA, 90212, US

(21) Appl. No.: 10/985,603

(22) Filed: Nov. 9, 2004

(51) Int. Cl. G06F 9/46

(52) U.S. Cl. 718/100

(57) ABSTRACT

Provided are a method and system for determining a number of processors to execute a task. A determination is made of a scaling factor indicating a marginal performance benefit of adding one of a plurality of processors to execute a task. The determined scaling factor is used to determine a number of processors to assign to execute the task and the task is executed using the determined number of processors.

### BACKGROUND

One consequence of increasing microprocessor performance is the increased amount of power needed to operate these improved and more powerful microprocessors. Certain systems include an operating system software approach that controls the processor to operate at different power levels depending on the requirements of the application being executed. Certain microprocessors also allow the voltage to be adjusted. The goal of such programs that adjust voltage is to reduce the performance of the processor without causing an application to miss deadlines. Further, completing a task before a deadline and then idling is less energy efficient than running the task at a slower speed in order to meet the deadline exactly.

### BRIEF DESCRIPTION OF THE DRAWINGS

FIG. 1 illustrates an embodiment of a computing environment.

FIGS. 2 and 3 illustrate operations to select a number of processors to execute a task.

### DETAILED DESCRIPTION

In the following description, reference is made to the accompanying drawings which form a part hereof and which illustrate several embodiments. It is understood that other embodiments may be utilized and structural and operational changes may be made without departing from the scope of the embodiments.

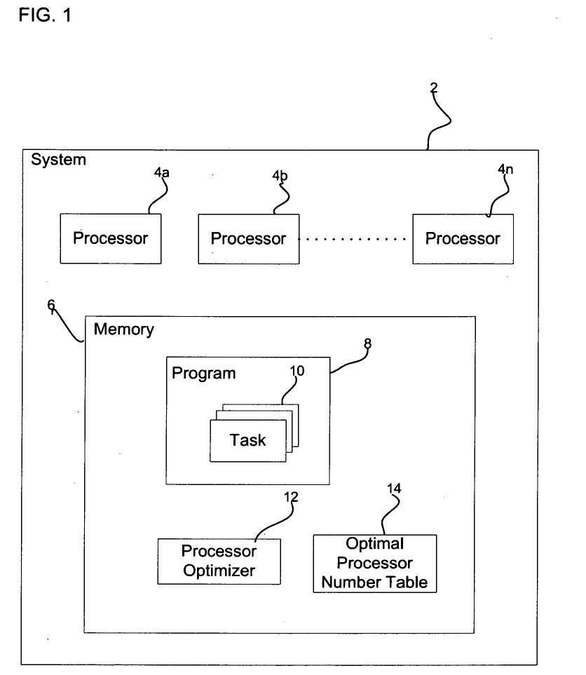

FIG. 1 illustrates a computer system 2 having a plurality of processors 4a, 4b . . . 4n and a memory 6. The processors 4a, 4b . . . 4n execute a program 8 having separately executable tasks 10 in the memory 6, where task(s) 10 refers to one or more tasks. A processor optimizer 12 program executed in the memory 6 determines a number of processors 4a, 4b . . . 4n to use to execute the tasks. The processor optimizer 12 may be executed by one or more of the processors 4a, 4b . . . 4n or separate processor or hardware component, such as an Application Specific Integrated Circuit (ASIC). In one embodiment, the processor optimizer 12 comprises an operating system program.

The system 2 may comprise computational devices known in the art. The memory 6 may comprise a volatile memory device in which programs and instructions are loaded to execute. The processors 4a, 4b . . . 4n may comprise separate processors each on a separate integrated circuit die. In an alternative embodiment, the processors 4a, 4b . . . 4n may comprise cores on a single integrated circuit die, such as a multi-core processor. In one embodiment, the processor optimizer 12 may independently control each of the processors' 4a, 4b . . . 4n voltage and frequency settings, such that different voltage levels may be applied to different of the processors 4a, 4b . . . 4n.

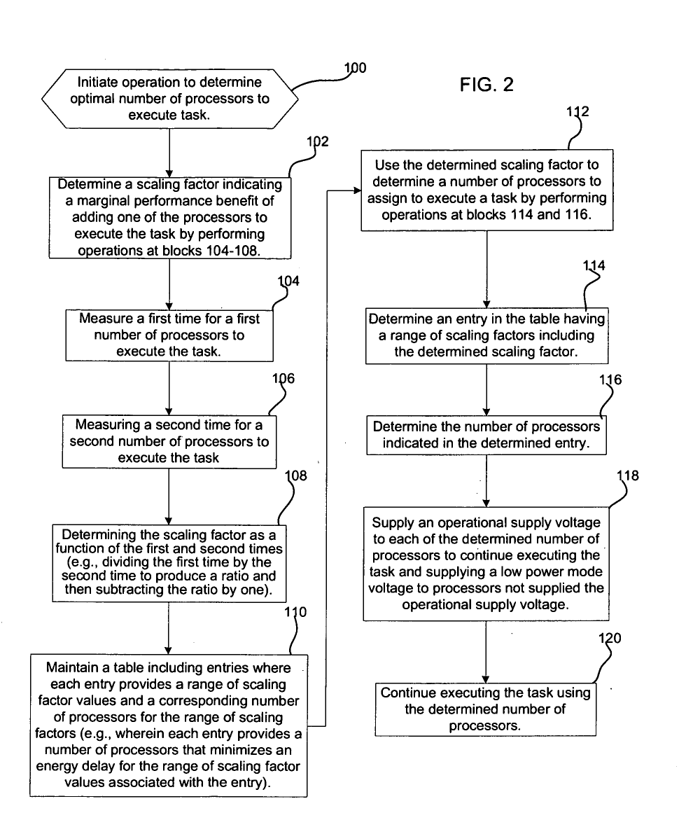

FIG. 2 illustrates operations performed by the processor optimizer 12 to select a number of processors 4a, 4b . . . 4n to use to execute one of the tasks 10. The processor optimizer 12 initiates (at block 100) operations to determine an optimal number of processors to execute a task 10. In one embodiment, the operations at block 100 may be initiated while processing one task 10 to dynamically adjust the number of processors being used to execute the task(s) 10 to take into account changed circumstances during execution. Alternatively, these operations to determine the number of processors may be initiated before executing one or more tasks 10 to determine the number of processors 4a, 4b . . . 4n to use to execute one or more tasks 10. Processor performance may be affected during runtime by environmental factors, such as temperature, etc., and other programs that are concurrently executing at a given point in time. The processor optimizer 12 determines (at block 102) a scaling factor indicating a marginal performance benefit of adding one of the processors to execute the task 10, otherwise known as the parallelism of the task 10 code for which this determination is being made. The parallelism of code indicates the benefit of adding processors to concurrently execute the in parallel by different processors 4a, 4b . . . 4n.

In one embodiment, the processor optimizer 12 may perform the operations at blocks 104-108 to determine the scaling factor. At blocks 104 and 106, the processor optimizer 12 measures a first time for a first number of processors to execute the task and a second time for a second number of processors to execute the task. Thus, in one embodiment, the task is executed while doing the testing for the optimal number of processors. The scaling factor is determined (at block 108) as a function of the first and second times (e.g., dividing the first time by the second time to produce a ratio and then subtracting the ratio by one). Equation (1) provides one embodiment for calculating the scaling factor (s) where the first time comprises t₁ and the second time comprises t₂.

$$s = \frac{{t}_{1}}{{t}_{2}} - 1 \qquad ( 1 )$$

In one embodiment, the first and second number of processors may comprise consecutive numbers, such as two and three or three and four processors. As discussed, the first and second times for the scaling factor may be calculated while executing the task as part of an initial determination of the optimal number of processors 4a, 4b . . . 4n or as part of a dynamic adjustment of the number of processors to use during task execution. Alternatively, the task executed by the different number of processors 4a, 4b . . . 4n may comprise a test task specialized code that is used for calculating the scaling factor. In one alternative embodiment,

In one embodiment, the processor optimizer 12 maintains an optimal processor number table 14 including entries where each entry provides a range of scaling factor values and a corresponding number of processors for the range of scaling factors. In one embodiment, each entry provides a number of processors that minimizes an energy delay for the range of scaling factor values associated with the entry. The energy delay (Q) may be calculated by calculating the performance (tᵣᵤₙ) time to execute the process and power expended (Pₜₒₜ) using the additional processor to execute the task. The energy delay (Q) comprises the amount of energy expended over the runtime, i.e., the total cost of the computation.

The performance time (tᵣᵤₙ) to execute the task may be calculated using the scaling factor (s) and the operating frequency (f) of the processors 4a, 4b, 4n as shown below in equation (2).

$$\frac{1 - s}{f ( 1 - {s}^{n} )} \qquad ( 2 )$$

An amount of power consumed (Pₜₒₜ) to execute the task 10 with the number of processors (n) may be calculated using the operating frequency (f), an operating voltage (V_{dd}) supplied to the processors 4a, 4b . . . 4n, a processor-type specific static energy constant (k_{tech}) indicating energy leakage for the processor 4a, 4b . . . 4n, and the number of processors (n) as shown in equation (3) below.

$${P}_{tot} = ( \frac{{V}_{dd} + {k}_{tech}}{{V}_{dd} + {V}_{dd} \cdot {k}_{tech}} ) \cdot n \cdot {V}_{dd}^{2} \cdot f \qquad ( 3 )$$

Equations (2) and (3) can be modified and modeled depending on the design of the processor, such that the scaling factor and power consumed to execute the task is dependent on the design of the processors. For instance, equations (2) and (3) are calculated based on the number of processors (n). In alternative embodiments, these equations may be calculated as some function of the number of processors (n), e.g., n multiplied or divided by some value or some other function (linear or non-linear) of n. For instance, in equation (3), the power consumed (Pₜₒₜ) increases linearly as the number of processors (n) increases, e.g., two processors use twice as much power as a single processor. However, for multiple processors/cores implemented on a single integrated circuit die, increasing processors may not linearly increase the amount of power consumed (Pₜₒₜ) because the multiple-cores may share certain resources. In such case, some fraction or other function of the number of processors (n) may be used, e.g., n/k, where k is constant. Thus, adjusting the number of processors (n) in equations (2) and (3) controls how the scaling factor and consumed power are calculated as the number of processors increases.

The total energy expended (Eₜₒₜ) with the number of processors (n) may be calculated by multiplying the performance time (tᵣᵤₙ) times the power expended (Pₜₒₜ) as shown in equation (4) below.

$${E}_{tot} = ( \frac{{V}_{dd} + {k}_{tech}}{{V}_{dd} + {V}_{dd} \cdot {k}_{tech}} ) \cdot ( \frac{n \cdot {V}_{dd}^{2} ( 1 - s )}{( 1 - {s}^{n} )} ) \qquad ( 4 )$$

The energy delay (Q) comprises the product of the total energy to execute the task 10 (Eₜₒₜ) and the performance time (tᵣᵤₙ) to execute the task 10, which comprises the amount of energy expended over the runtime, i.e., the total cost of the computation. The energy delay (Q) may be calculated according to equation (5) below:

$$Q = {E}_{tot} \cdot {t}_{run} = ( \frac{{V}_{dd} + {k}_{tech}}{{V}_{dd} + {V}_{dd} \cdot {k}_{tech}} ) \cdot ( \frac{n \cdot {( 1 - s )}^{2}}{{( 1 - {s}^{n} )}^{2}} ) \qquad ( 5 )$$

The number of processors (n) selected to minimize the energy delay (Q) may be solved by computing a derivative of the energy delay (Q) with respect to the number of processors (n) to produce a value of zero. Equation (6) below shows the derivative to determine the number of processors (n) to minimize the energy delay (Q).

$$\frac{ⅆ Q}{ⅆ n} = 0 ; where n \geq 1 and 0 \leq s < 1 \qquad ( 6 )$$

The developer of the optimal processor number table 14 may then solve the above differential equation to determine different numbers of processors (n) for different ranges of scaling factors, where each entry in the table indicates a range of scaling factor values and the corresponding optimal number of processors (n) for a scaling factor falling in that range to minimize the energy delay, or total energy consumption over the execution time.

The processor optimizer 12 uses (at block 112) the determined scaling factor to determine a number of processors to assign to execute a task. In one embodiment where the optimal processor number table 14 is maintained, the processor optimizer 12 may perform the operations at blocks 114 and 116 to determine the optimal number of processors to use to process the task. At block 114, the processor optimizer 12 determines an entry in the table 14 having a range of scaling factors including the determined scaling factor and determines (at block 116) the number of processors indicated in the determined entry. The processor optimizer 12 then causes the system 2 to supply (at block 118) an operational supply voltage to each of the determined number of processors to execute the task and supply a low power mode voltage to processors not supplied the operational supply voltage. In one embodiment, the processor optimizer 12 may cause voltage to be supplied independently to the processors 4a, 4b . . . 4n, so that some processors may be supplied the operating voltage and others a lower power mode voltage. The determined number of processors 4a, 4b . . . 4n supplied the operating voltage execute (at block 120) the task 12.

In one embodiment, the processor optimizer 12 may not maintain the optimal processor number table 14 and instead calculate the optimal number of processors by solving the differential equation (6).

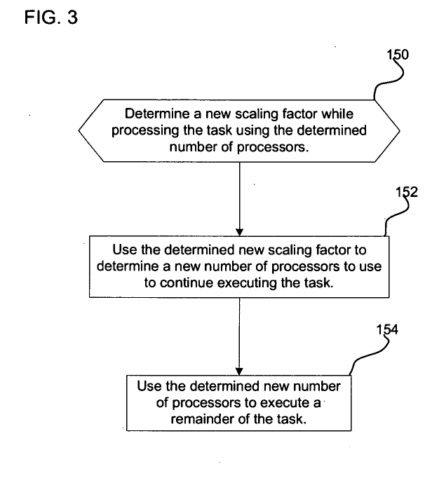

The operations of FIG. 2 may be performed at the start of executing the task 10 or during execution of the task to determine an optimal number of processors to use to continue executing the specific task 10. FIG. 3 illustrates an additional embodiment where the optimal number of processors 4a, 4b . . . 4n is calculated dynamically during execution of the task to determine if the number of processors 4a, 4b . . . 4n being used to execute the task 10 should be modified. The operations of FIG. 3 to dynamically adjust the number of processors used to execute the task during task execution may be performed periodically or if certain performance thresholds are not satisfied after a previous optimization. In such embodiments, the processor optimizer. 12 determines (at block 150) a new scaling factor while processing the task 10 using the determined number of processors, determined according to the operations of FIG. 2. The processor optimizer 12 uses (at block 152) the determined new scaling factor to determine a new number of processors 4a, 4b . . . 4n to use to continue executing the remainder of the task 10. The processor optimizer 12 may use the operations described with respect to FIG. 2 to determine the optimal number of processors. The determined new number of processors 4a, 4b . . . 4n are then used (at block 154) to execute a remainder of the task 10. The processor optimizer 12 may cause the supply of operational voltage to the new number of processors and a lower power mode voltage to the other processors.

Described embodiments provide techniques to determine an optimal number of processors to use to execute a task taking into account the parallelism of the code of the task to execute, i.e., scaling factor, the performance time to execute the task based on the scaling factor, and the energy expended to execute the task with the optimal number of processors.

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the embodiments, and that the article of manufacture may comprise any information bearing medium known in the art.

The described operations may be performed by circuitry, where “circuitry” refers to either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

The illustrated operations of FIGS. 2 and 3 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The above described equations for calculating performance time (equation (2)), time, power consumed (equation (3)), and energy delay (equation (5)) may include additional variables, such as frequency.

The foregoing description of various embodiments has been presented for the purposes of illustration and description. It is not intended to be exhaustive or to limit the embodiments to the precise form disclosed. Many modifications and variations are possible in light of the above teaching.

What is claimed is:

1. A method comprising:
determining a scaling factor indicating a marginal performance benefit of adding one of a plurality of processors to execute a task;
using the determined scaling factor to determine a number of processors to assign to execute the task; and
executing the task using the determined number of processors.

2. The method of claim 1, wherein determining the scaling factor comprises:
measuring a first time for a first number of processors to execute the task; and
measuring a second time for a second number of processors to execute the task, wherein the scaling factor is determined as a function of the first and second time.

3. The method of claim 2, wherein the second number of processors is one plus the first number of processors, and wherein the function of the first and second times comprises:
dividing the first time by the second time to produce a ratio and then subtracting the ratio by one.

4. The method of claim 1, further comprising:
maintaining a table including entries where each entry provides a range of scaling factor values and a corresponding number of processors for the range of scaling factors, wherein using the determined scaling factor comprises:
(i) determining one entry in the table having a range of scaling factors including the determined scaling factor; and
(ii) determining the number of processors indicated in the determined entry.

5. The method of claim 4, wherein each entry provides a number of processors that minimizes an energy delay for the range of scaling factor values associated with the entry.

6. The method of claim 1, wherein using the determined scaling factor comprises:
using the scaling factor to determine an energy delay comprising total energy consumed to process the task times a total run time to process the task, wherein the determined number of processors minimizes the energy delay.

7. The method of claim 6, wherein determining the number of processors to minimize the energy delay comprises solving the number of processors by computing a derivative of the energy delay with respect to the number of processors that is equal to zero.

8. The method of claim 7, wherein the energy delay is a function of a voltage supplied to the processors, a technology specific static energy constant, the number of processors being solved, and the determined scaling factor.

9. The method of claim 1, wherein the operation of determining the scaling factor is performed during runtime while or before executing the task.

10. The method of claim 9, further comprising:
determining a new scaling factor while processing the task using the determined number of processors;
using the determined new scaling factor to determine a new number of processors to use to continue executing the task; and
using the determined new number of processors to execute a remainder of the task.

11. The method of claim 1, wherein using the number of processors comprises supplying an operational supply voltage to each of the determined number of processors to execute the task and supplying a low power mode voltage to processors not supplied the operational supply voltage.

12. The method of claim 1, wherein the multiple processors comprise multiple cores implemented on a single integrated circuit die.

13. The method of claim 1, wherein power is supplied independently to the processors.

14. A system comprising:
a plurality of processors;
a memory including a task for at least one of the processors to execute;
a computer readable medium including a processor optimizer program executed by at least one of the processors to cause operations to be performed, the operations:
(i) determining a scaling factor indicating a marginal performance benefit of adding one of the processors to execute the task;
(ii) using the determined scaling factor to determine a number of processors to assign to execute a task; and
(iii) causing the determined number of processors to execute the task.

15. The system of claim 14, wherein determining the scaling factor comprises:
measuring a first time for a first number of processors to execute the task; and
measuring a second time for a second number of processors to execute the task, wherein the scaling factor is determined as a function of the first and second time.

16. The system of claim 15, wherein the second number of processors is one plus the first number of processors, and wherein the function of the first and second times comprises:
dividing the first time by the second time to produce a ratio and then subtracting the ratio by one.

17. The system of claim 14, wherein the operations caused by executing the processor optimizer program further comprise:
maintaining a table including entries where each entry provides a range of scaling factor values and a corresponding number of processors for the range of scaling factors, wherein using the determined scaling factor comprises:
(i) determining one entry in the table having a range of scaling factors including the determined scaling factor; and
(ii) determining the number of processors indicated in the determined entry.

18. The system of claim 17, wherein each entry provides a number of processors that minimizes an energy delay for the range of scaling factor values associated with the entry.

19. The system of claim 14, wherein using the determined scaling factor comprises:
using the scaling factor to determine an energy delay comprising total energy consumed to process the task times a total run time to process the task, wherein the determined number of processors minimizes the energy delay.

20. The system of claim 19, wherein determining the number of processors to minimize the energy delay comprises solving the number of processors by computing a derivative of the energy delay with respect to the number of processors that is equal to zero.

21. The system of claim 20, wherein the energy delay is a function of a voltage supplied to the processors, a technology specific static energy constant, the number of processors being solved, and the determined scaling factor.

22. The system of claim 14, wherein the operation of determining the scaling factor is performed during runtime while or before executing the task.

23. The system of claim 14, wherein the operations caused by executing the processor optimizer program further comprise:
determining a new scaling factor while processing the task using the determined number of processors;
using the determined new scaling factor to determine a new number of processors to use to continue executing the task; and
using the determined new number of processors to execute a remainder of the task.

24. The system of claim 14, wherein using the number of processors comprises supplying an operational supply voltage to each of the determined number of processors to execute the task and supplying a low power mode voltage to processors not supplied the operational supply voltage.

25. The system of claim 14, further comprising:
an integrated circuit die including the plurality of processors.

26. The system of claim 14, wherein power is supplied independently to the processors.

27. An article of manufacture to determine a number of processors to use to execute a task, wherein the article of manufacture causes operations to be performed, the operations comprising:
determining a scaling factor indicating a marginal performance benefit of adding one of the processors to execute the task;
using the determined scaling factor to determine a number of processors to assign to execute a task; and
executing the task using the determined number of processors.

28. The article of manufacture of claim 27, wherein determining the scaling factor comprises:
measuring a first time for a first number of processors to execute the task; and
measuring a second time for a second number of processors to execute the task, wherein the scaling factor is determined as a function of the first and second time.

29. The article of manufacture of claim 28, wherein the second number of processors is one plus the first number of processors, and wherein the function of the first and second times comprises:
dividing the first time by the second time to produce a ratio and then subtracting the ratio by one.

30. The article of manufacture of claim 27, wherein the operations further comprise:
maintaining a table including entries where each entry provides a range of scaling factor values and a corresponding number of processors for the range of scaling factors, wherein using the determined scaling factor comprises:
(i) determining one entry in the table having a range of scaling factors including the determined scaling factor; and
(ii) determining the number of processors indicated in the determined entry.

31. The article of manufacture of claim 30, wherein each entry provides a number of processors that minimizes an energy delay for the range of scaling factor values associated with the entry.

32. The article of manufacture of claim 27, wherein using the determined scaling factor comprises:
using the scaling factor to determine an energy delay comprising total energy consumed to process the task times a total run time to process the task, wherein the determined number of processors minimizes the energy delay.

33. The article of manufacture of claim 32, wherein determining the number of processors to minimize the energy delay comprises solving the number of processors by computing a derivative of the energy delay with respect to the number of processors that is equal to zero.

34. The article of manufacture of claim 33, wherein the energy delay is a function of a voltage supplied to the processors, a technology specific static energy constant, the number of processors being solved, and the determined scaling factor.

35. The article of manufacture of claim 27, wherein the operation of determining the scaling factor is performed during runtime while or before executing the task.

36. The article of manufacture of claim 35, wherein the operations further comprise:
determining a new scaling factor while processing the task using the determined number of processors;
using the determined new scaling factor to determine a new number of processors to use to continue executing the task; and
using the determined new number of processors to execute a remainder of the task.

37. The article of manufacture of claim 27, wherein using the number of processors comprises supplying an operational supply voltage to each of the determined number of processors to execute the task and supplying a low power mode voltage to processors not supplied the operational supply voltage.

38. The article of manufacture of claim 27, wherein the multiple processors comprise multiple cores implemented on a single integrated circuit die.

39. The article of manufacture of claim 27, wherein power is supplied independently to the processors.

40. A system comprising:
an integrated circuit die including a plurality of processor cores;
a memory including a task for at least one of the processor cores to execute;
a computer readable medium including a processor optimizer program executed by at least one of the processor causes to cause operations to be performed, the operations:
(i) determining a scaling factor indicating a marginal performance benefit of adding one of the processor cores to execute the task;
(ii) using the determined scaling factor to determine a number of processor cores to assign to execute a task; and
(iii) causing the determined number of processor cores to execute the task.

41. The system of claim 40, wherein using the determined scaling factor comprises:
using the scaling factor to determine an energy delay comprising total energy consumed to process the task times a total run time to process the task, wherein the determined number of processor cores minimizes the energy delay.
